(19) United States
(12) Patent Application Publication
(10) Pub. No.: US 2026/0098836 A1
(43) Pub. Date: Apr. 9, 2026

(54) FLUID PROPERTY MEASUREMENT SYSTEMS INCLUDING A WAVEGUIDE, AND RELATED SYSTEMS, COMPONENTS, AND METHODS

(71) Applicant: Battelle Energy Alliance, LLC, Idaho Falls, ID (US)

(72) Inventors: Joshua E. Daw, Idaho Falls, ID (US); Mustafa S. Cetiner, Cambridge, MA (US); Bibo Zhong, Idaho Falls, ID (US)

(21) Appl. No.: 19/352,900

(22) Filed: Oct. 8, 2025

Related U.S. Application Data
(60) Provisional application No. 63/705,346, filed on Oct. 9, 2024.

(51) Int. Cl. G01N 29/024; G01F 1/66; G01F 23/2962

(52) U.S. Cl. CPC G01N 29/024; G01F 1/662; G01F 23/2963; G01N 2291/02818; G01N 2291/02881

(57) ABSTRACT

A fluid property measurement system, comprising at least one waveguide. A sheath substantially surrounds the waveguide and is arranged coaxially with the waveguide. An electronic assembly is operatively coupled to the waveguide and the sheath, the electronic assembly configured to produce a first torsional ultrasonic wave signal through the waveguide, a second torsional ultrasonic wave signal through the sheath, and a longitudinal ultrasonic wave signal through at least one of the waveguide and the sheath. An energy system and a method of measuring properties of a fluid are also disclosed.

### CROSS-REFERENCE TO RELATED APPLICATIONS

This application claims the benefit under 35 U.S.C. § 119 (e) of U.S. Provisional Patent Application Ser. No. 63/705,346, filed Oct. 9, 2024, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

The disclosure, in various embodiments, relates generally to fluid property measurement systems. More particularly, this disclosure relates to fluid property measurement systems including a waveguide and associated systems, components, and methods.

### BACKGROUND

Fluid properties, such as level, density, viscosity, and temperature, must be detected and tracked by the process measurement and control systems found in many industrial contexts. A wide variety of industries need process-measurement sensors that reliably and accurately quantify fluid properties across a wide array of harsh operating conditions, while having extended service lives and ease of maintenance and replacement. Conventional fluid sensing approaches, such as floats and displacers, differential-pressure sensors, capacitance or conductance probes, ultrasonic or radar level instruments, densitometers, Coriolis meters, rotational or oscillatory viscometers, and thermocouples or resistance temperature detectors (RTDs) can be used in combination with one another to provide different measurements of fluid properties. Industrial applications, such as installations in nuclear reactors (e.g., primary and secondary coolant circuits, fuel storage pools, and waste tanks), petroleum processing facilities (e.g., upstream separation, refining, and petrochemical units), plastics manufacturing lines (e.g., polymerization, compounding, and extrusion trains), metals manufacturing (e.g., smelting, coating, extrusion, and casting), and other monitored environments frequently expose sensors to elevated pressures and temperatures, rapid transients, caustic and corrosive conditions, multiphase regimes (e.g., flashing, foaming, entrained gas and solids), and substantial electromagnetic, vibrational, and radiation interference, which can degrade sensor function.

### SUMMARY

A fluid property measurement system comprises a waveguide. The system further comprises a sheath that substantially surrounds the waveguide and is arranged coaxially with the waveguide. The system further comprises an electronic assembly operatively coupled to the waveguide and the sheath. The electronic assembly is configured to produce a first torsional ultrasonic wave signal through the waveguide. The electronic assembly is further configured to produce a second torsional ultrasonic wave signal through the sheath. The electronic assembly is further configured to produce a longitudinal ultrasonic wave signal through at least one of the waveguide and the sheath.

An energy system comprises a cooling system. The energy system further comprises at least one fluid chamber of the cooling system configured to house a cooling fluid. The energy system further comprises a waveguide disposed in the at least one fluid chamber. The waveguide comprises a sensing segment configured to be at least partially disposed in the cooling fluid. The waveguide further comprises a driving segment comprising at least two driving elements. The at least two driving elements are configured to generate a longitudinal ultrasonic wave signal and a torsional ultrasonic wave signal in the sensing segment.

A method of measuring properties of a fluid comprises disposing a waveguide of a fluid property measurement system at least partially within the fluid. The method further comprises generating a first torsional ultrasonic wave in the waveguide. The method further comprises measuring an amount of time for the first torsional ultrasonic wave and reflections of the first torsional ultrasonic wave to travel through the waveguide. The method further comprises substantially simultaneously determining one or more of a level of the fluid, a density of the fluid, and a viscosity of the fluid based on a difference between the measured amounts of time.

### BRIEF DESCRIPTION OF THE DRAWINGS

FIG. 1 is a diagram of an energy system in accordance with embodiments of the disclosure;

FIG. 2 is a perspective view of a waveguide of the energy system in accordance with embodiments of the disclosure;

FIG. 3 is an enlarged perspective view of a portion of the waveguide of FIG. 2;

FIG. 4 is an enlarged perspective view of a portion of a waveguide in accordance with embodiments of the disclosure;

FIG. 5 is an enlarged perspective view of a portion of a waveguide in accordance with embodiments of the disclosure;

FIG. 6 is an enlarged perspective view of a portion of a waveguide in accordance with embodiments of the disclosure;

FIG. 7 is an enlarged perspective view of a driving segment of the waveguide of FIG. 3;

FIG. 8A is an enlarged perspective view of a driving segment of the waveguide in accordance with embodiments of the disclosure;

FIG. 8B is an enlarged perspective view of a driving segment of the waveguide in accordance with embodiments of the disclosure;

FIG. 8C is an enlarged perspective view of a driving segment of the waveguide in accordance with embodiments of the disclosure;

FIG. 9 is an enlarged perspective view of a driving segment of the waveguide in accordance with embodiments of the disclosure;

FIG. 10 is a perspective view of a sheath of the energy system in accordance with embodiments of the disclosure;

FIG. 11 is a side cross-sectional view of a temperature sensor of the energy system in accordance with embodiments of the disclosure; and

FIG. 12 illustrates a routine for determining one or more properties of a fluid in accordance with one embodiment.

### DETAILED DESCRIPTION

In the detailed description, the claims, and in the accompanying drawings, reference is made to particular features (including method acts) of the disclosure. It is to be understood that the disclosure includes all possible combinations of such features. For example, where a particular feature is disclosed in the context of a particular embodiment, or a particular claim, that feature can also be used, to the extent possible, in combination with and/or in the context of other aspects and embodiments described herein.

The following description provides specific details, such as components, assemblies, and materials in order to provide a thorough description of embodiments of the disclosure. However, a person of ordinary skill in the art will understand that the embodiments of the disclosure may be practiced without employing these specific details.

Drawings presented herein are for illustrative purposes and are not necessarily meant to be actual views of any particular material, component, structure, or device. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

The use of the term “for example,” means that the related description is explanatory, and though the scope of the disclosure is intended to encompass the examples and legal equivalents, the use of such terms is not intended to limit the scope of an embodiment of this disclosure to the specified components, acts, features, functions, or the like.

As used herein, the term “configured to” in reference to a structure or device intended to perform some function refers to size, shape, material composition, material distribution, orientation, and/or arrangement, etc., of the referenced structure or device.

As used herein, the term “may” with respect to a material, structure, feature, or method act indicates that such is contemplated for use in implementation of an embodiment of the disclosure and such term is used in preference to the more restrictive term “is” so as to avoid any implication that other, compatible materials, structures, features and methods usable in combination therewith should or must be excluded.

As used herein, the singular forms following “a,” “an,” and “the” are intended to include the plural forms as well, unless the context clearly indicates otherwise.

As used herein, any relational term, such as “first,” “second,” “top,” “bottom,” “upper,” “lower,” “above,” “beneath,” “side,” “upward,” “downward,” etc., may be used for ease of description to describe one element's or feature's relationship to another element(s) or feature(s) as illustrated in the drawings. Unless otherwise specified, the spatially relative terms are intended to encompass different orientations of the materials in addition to the orientation depicted in the figures. For example, if materials in the figures are inverted, elements described as “below” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, even at least 99.9% met, or even 100% met.

As used herein, “about” in reference to a numerical value for a particular parameter is inclusive of the numerical value and a degree of variance from the numerical value that one of ordinary skill in the art would understand is within acceptable tolerances for the particular parameter. For example, “about” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the term “and/or” means and includes any and all combinations of one or more of the associated listed items.

As used herein, the terms “vertical,” “longitudinal,” “horizontal,” and “lateral” are in reference to a major plane of a structure and are not necessarily defined by earth's gravitational field. A “horizontal” or “lateral” direction is a direction that is substantially parallel to the major plane of the structure, while a “vertical” or “longitudinal” direction is a direction that is substantially perpendicular to the major plane of the structure. The major plane of the structure is defined by a surface of the structure having a relatively large area compared to other surfaces of the structure. In figures that define an XYZ coordinate system with a shown XYZ compass, a “horizontal” or “lateral” direction is a direction that is substantially parallel to the XY plane defined, while a “vertical” or “longitudinal” direction is a direction that is substantially perpendicular to the XY plane defined.

As discussed above, there is a need across a wide variety of industries for process-measurement sensors that can reliably and accurately quantify fluid properties, such as level, density, viscosity, and temperature. It is desirable to have sensors that are capable of operating across a wide array of harsh operating conditions, while having extended service lives with ease of maintenance and replacement. Installations in nuclear reactors, petroleum processing facilities, plastics manufacturing lines, metals manufacturing lines, and other monitored fluid processing environments frequently expose sensors to elevated pressures and temperatures, rapid transients, caustic and corrosive conditions, multiphase regimes (e.g., flashing, foaming, entrained gas and solids), and substantial electromagnetic, vibrational, and radiation interference, which can degrade fluid property sensing function.

Conventional systems may utilize multiple individual sensors to monitor the different fluid properties, (e.g., level, density, viscosity, and temperature); each of these sensors take up space, which can be a very limited resource in industrial system designs. Consolidating the sensors into a single system may result in reduced space requirements, which may facilitate more flexibility in the associated industrial system design. Additionally, installing and maintaining a single sensor rather than multiple discrete sensors may reduce labor costs for installation and maintenance of sensors.

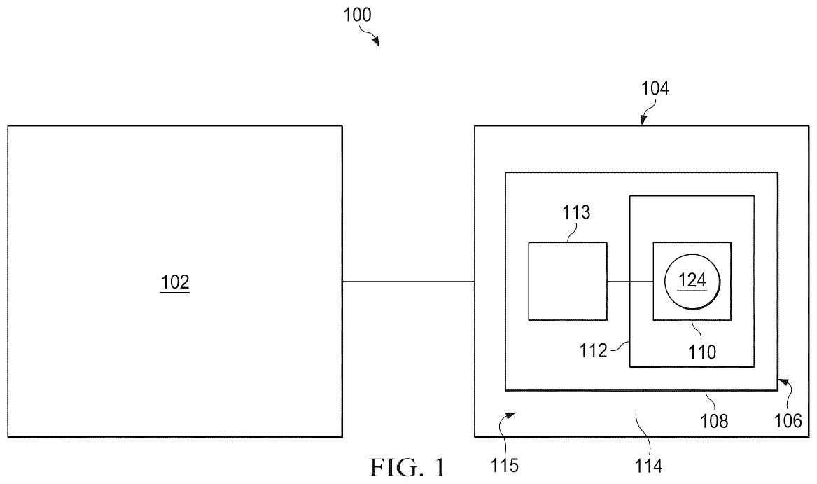

FIG. 1 illustrates a block diagram of an energy system 100. The energy system 100 may include a reactor 102 and one or more cooling systems 104 operatively coupled to the reactor 102. While embodiments describe the energy system 100 as including the reactor 102, the energy system 100 may include a reactor vessel, primary coolant loop, secondary coolant loop, or other reactor-related liquid system, such as a used fuel pool. In other embodiments, the reactor 102 and at least one cooling system 104 may be a single structure. For example, the cooling system 104 may form part of the reactor 102, such as a molten salt reactor where the cooling fluid contains the fuel of the reactor.

A fluid 114 may act as coolant in the energy system 100. The fluid 114 may be a water (i.e., aqueous) coolant or a non-aqueous coolant, such as a molten salt or liquid metal. The reactor 102 may be a fluid-cooled reactor, such as a water-cooled reactor, a gas-cooled reactor, a molten salt reactor, or a liquid metal reactor. The cooling system 104 is configured to circulate a fluid 114 through both the reactor 102 and the cooling system 104 to transfer heat generated in the reactor 102 and maintain safe operating conditions within the energy system 100. For example, the cooling system 104 may circulate the fluid 114 from the core of the reactor 102 to a heat engine, such as for generating electricity or mechanical work from the heat generated by the reactor 102. In other embodiments, the cooling system 104 may circulate the fluid 114 from the reactor 102 to a heat removal system to remove heat from the energy system 100. In some embodiments, the fluid 114 is moved by one or more pumping systems. In other embodiments, the energy system 100 is configured such that the fluid 114 moves through the system through natural convection driven by the addition and removal of heat in the fluid 114.

The cooling system 104 includes at least one fluid property measurement system 106. The fluid property measurement system 106 includes a housing 108, a waveguide 110, a sheath 112, and an electronics assembly 113 operatively connected to the waveguide 110 and the sheath 112. The fluid property measurement system 106 may be used to determine (e.g., measure, monitor) physical properties of the fluid 114 (e.g., the aqueous or the non-aqueous coolant) within the cooling system 104 by measuring changes in the fluid 114. The fluid property measurement system 106 may, for example, be used to determine one or more of a temperature, a fluid level, a density, and a viscosity of the fluid 114. The fluid temperature, fluid level, fluid density, and viscosity of the fluid may be determined substantially simultaneously by a single fluid property measurement system 106. Advanced reactors have a smaller coolant volume relative to existing reactors so measuring the fluid level by conventional techniques may be less accurate. In addition, advanced reactors operate under harsher conditions, such as at higher temperatures and in corrosive environments.

In some embodiments, the fluid property measurement system 106 includes a single waveguide 110 and is configured to determine one or more of the temperature, fluid level, density, and viscosity of the fluid 114 substantially simultaneously. In other embodiments, the fluid property measurement system 106 includes a plurality of waveguides (e.g., acoustic waveguides) 110 and/or a plurality of sheaths 112. In yet other embodiments, the energy system 100 includes a plurality of fluid property measurement systems 106 located at various points throughout the energy system 100. The waveguide 110 and the sheath 112 may be located at least partially within or operatively connected to the housing 108. The waveguide 110 and the sheath 112 may be formed from a material that is configured to withstand the environment in which the waveguide 110 and the sheath 112 are disposed. For example, in a molten salt reactor, the waveguide 110 and the sheath 112 may be formed from a material that is configured to withstand the corrosive, high temperature, and pressure environment of the molten salts. In other applications, where the environment is less harsh, such as an aqueous coolant, the waveguide 110 and the sheath 112 may be formed from different materials. The waveguide 110 and the sheath 112 may be formed from and include solid materials such as stainless steel, molybdenum, sapphire, niobium, aluminum, an aluminum alloy, aluminum-oxide, silicon carbide, zirconium, a zirconium alloy, a nickel-chromium alloy (e.g., an INCONEL® alloy), tungsten, a tungsten alloy, titanium, a titanium alloy, or other alloys that maintain their structural integrity at the operating temperature and pressure of the energy system 100. Additionally, the waveguide 110 and the sheath 112 may be formed from and include other materials, such as glass (e.g., silica glass and lithiated glass), ceramics (e.g., aluminum oxide, lithium ortho-silicate Li₄SiO₄, and lithium meta-titanate Li₂TiO₃), glass-ceramics (e.g., lithium aluminum silicate (LAS)), or plastics. The waveguide 110 and the sheath 112 may also be formed from and include equivalents of the materials listed above. The choice of material for the waveguide 110 and sheath 112 construction may affect both the environmental suitability for harsh conditions (e.g., hot, cold, corrosive, radioactive, etc.) as well as the temperature sensitivity and the measurement properties of the fluid property measurement system 106. A stiffer material may also be used and will have greater dynamic range, capable of measuring smaller changes in fluid properties. The ultrasonic wave propagation speed will also vary based on the chosen material's properties, such as density.

The waveguide 110 and the sheath 112 may at least partially extend into the fluid 114 within the cooling system 104. The fluid 114 may be located within a fluid chamber 115. The fluid chamber 115 may be any portion of the cooling system 104 or the reactor 102 in which the fluid 114 is located in or through which it circulates. In some embodiments, the fluid 114 circulating through the energy system 100 may be maintained at a high temperature and pressure during its use and operation. For example, the temperature of the fluid 114 may reach a temperature within a range from about 20° C. to about 750° C., from about 200° C. to about 750° C., or higher. The pressure of the fluid 114 within the energy system 100 may be within a range from about 0.1013 MPa to about 40 MPa, from about 10 MPa to about 40 MPa, or higher.

The fluid 114 may be a non-aqueous substance such as a molten metal or a molten salt. As the fluid 114 is exposed to a high temperature and high-pressure environment within the energy system 100, the fluid 114 may undergo changes (e.g., chemical changes) that affect the properties of the fluid 114. The changes to the fluid 114 may change the level of the fluid 114 within the cooling system 104. The changes may also change one or more of the density and viscosity of the fluid 114, affecting the operation of the cooling system 104. The fluid property measurement system 106 may be configured to monitor one or more of the temperature, fluid level, density, and viscosity of the fluid 114 substantially simultaneously using an ultrasonic waveguide 110. Measuring the temperature, fluid level, density, and viscosity of the fluid 114 simultaneously may facilitate consistent and/or efficient operation of the energy system 100, improve the lifespan of the energy system 100, and may reduce the likelihood of failure of the energy system 100. The electronics assembly 113 may include one or more sensors, signal generators, receivers and other components to facilitate generating ultrasonic waves within the waveguide 110 and the sheath 112 and measuring the behavior of the ultrasonic wave as it travels along the length of the waveguide 110 and the sheath 112. The electronics assembly 113 may generate an electrical signal that causes the ultrasonic wave to be formed and pass through the waveguide 110 and the sheath 112, as discussed in more detail below.

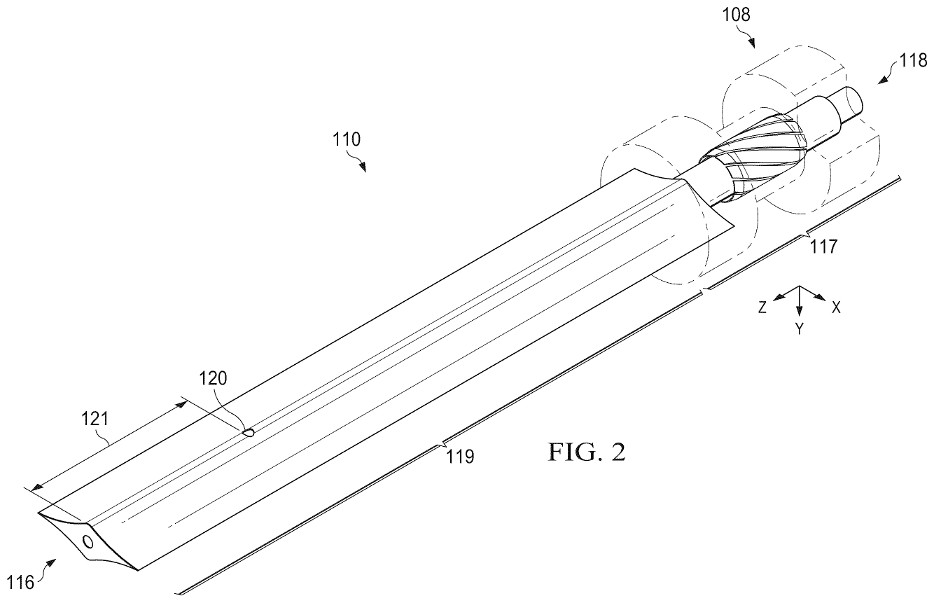

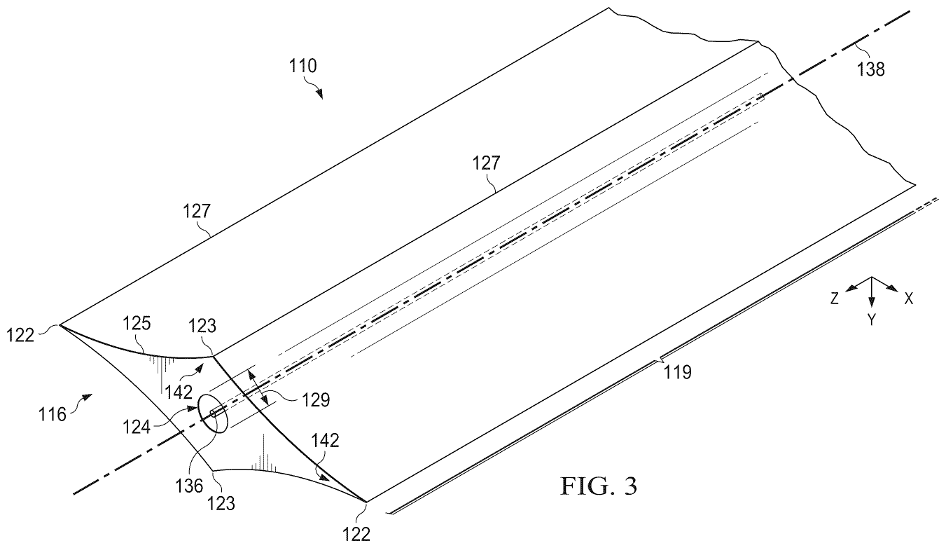

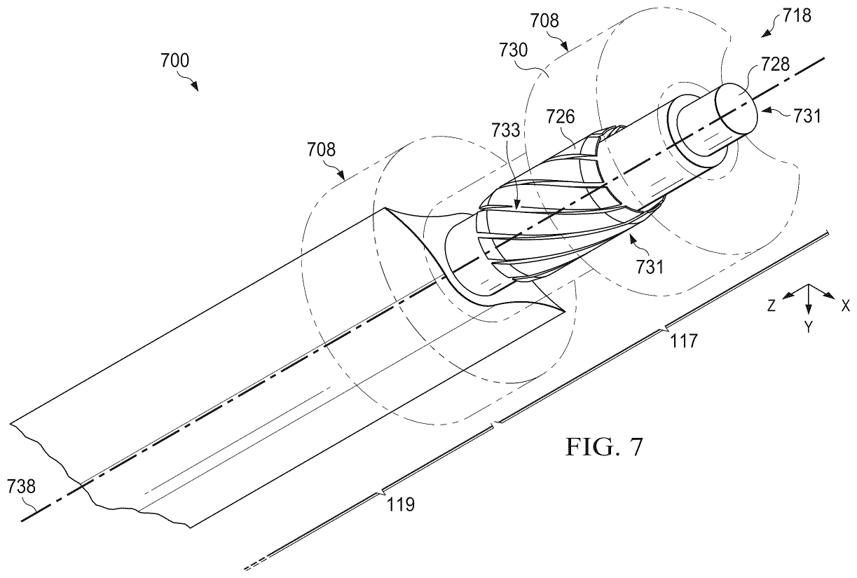

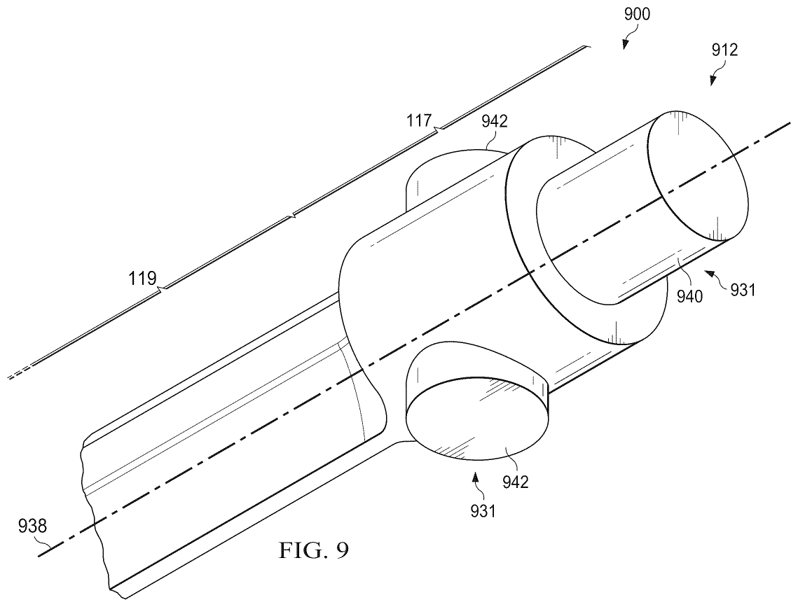

FIG. 2 illustrates an embodiment of the waveguide 110. The waveguide includes a driving segment 117 and a sensing segment 119. The sensing segment 119 extends to a first end 116 of the waveguide 110. The sensing segment 119 is configured to be at least partially disposed within the fluid 114 (FIG. 1), such that the first end 116 is disposed within the fluid 114 (FIG. 1). The second end 118 of the waveguide 110 is configured to be operatively connected to the housing 108. The sensing segment 119 of the waveguide 110 may exhibit a substantially cusped diamond shaped cross-section, as discussed in more detail with reference to FIG. 3. The driving segment 117 of the waveguide 110 is configured to receive a signal to produce an ultrasonic wave from the electronics assembly 113 (FIG. 1) in the housing 108, produce the ultrasonic wave, and transfer the ultrasonic wave along the waveguide 110. The driving segment 117 may be configured to produce at least one of a torsional ultrasonic wave, a shear ultrasonic wave, and a longitudinal ultrasonic wave. The ultrasonic wave may travel from the second end 118 of the waveguide 110 to the first end 116 of the waveguide 110 and back to the second end 118 of the waveguide 110. The electronics assembly 113 (FIG. 1) in the housing 108 may be configured to measure an amount of time it takes for the ultrasonic wave to travel from the second end 118 of the waveguide 110 to the first end 116 of the waveguide and back to the second end 118 of the waveguide 110. For example, the electronics assembly 113 (FIG. 1) may generate a signal that interacts with the second end 118 of the waveguide 110 and/or the sheath 112 (FIG. 1) to generate an ultrasonic wave pulse. The interaction between the waveguide 110 and the sheath 112 with the electronics assembly 113 (FIG. 1) is discussed further with regard to FIG. 7 and FIG. 9. The electronics assembly 113 (FIG. 1) may also be able to detect reflecting ultrasonic waves propagating back to the second end 118 of the waveguide 110 and the sheath 112 (FIG. 1) and measure the amount of time between ultrasonic wave generation and detection of the reflected ultrasonic waves. The amount of time it takes for the ultrasonic wave to propagate along the waveguide 110 may change based on the fluid level and physical properties of the fluid 114 (FIG. 1). The ultrasonic wave may, for example, travel relatively slower or relatively faster through the portion of the waveguide (FIG. 1) 110 or sheath 112 (FIG. 1) that is submerged in the fluid 114 (FIG. 1) if the temperature, level, density, or viscosity of the fluid 114 (FIG. 1) changes, because these variables affect the speed of the propagation of the ultrasonic wave. The ultrasonic wave may, for example, propagate faster through the waveguide 110 when submerged in a less dense fluid 114 (FIG. 1) than the time it takes for the wave to propagate through the waveguide 110 when submerged in a more dense fluid 114 (FIG. 1). The higher the fluid level within the energy system 100, the more of the waveguide that is submerged within the fluid 114 (FIG. 1). Accordingly, the level of the fluid 114 (FIG. 1) may be calculated based on the elapsed time between generation and detection of the reflected ultrasonic wave, taking into account the changes in propagation speed attributable to the separately measured properties of density, viscosity, and temperature of the fluid 114 (FIG. 1).

Similarly, the density of the fluid 114 (FIG. 1) may be calculated based on the amount of time it takes for the ultrasonic wave to propagate through a specific portion of the waveguide 110. As described above, the ultrasonic wave may propagate faster through the waveguide 110 when submerged in a less dense fluid 114 (FIG. 1) than the time it takes for the wave to propagate through the waveguide 110 when submerged in a more dense fluid 114 (FIG. 1). The measurement of fluid level and density may be conducted separately by measuring ultrasonic wave propagation speed in the submerged portion of the waveguide 110. In order to isolate the submerged portion for measurement, the waveguide 110 may include a hole 120. The hole 120 may be located at a distance 121 from the first end 116 of the waveguide 110. The distance 121 may be defined such that the hole 120 remains submerged in the fluid 114 (FIG. 1). When the ultrasonic wave signal travels through the waveguide 110 from the second end 118, a portion of the ultrasonic wave signal reflects from the first end 116 of the waveguide 110. A complementary portion of the ultrasonic wave signal reflects from the hole 120 and may be referenced to determine the fluid level. The portion of the ultrasonic wave signal that moves through the waveguide 110 in the region of the sensing segment 119 between the hole 120 and the first end 116 may be referenced for determining the density of the fluid, because the region of the sensing segment 119 between the hole 120 and the first end 116 is fully submerged in the fluid 114 (FIG. 1).

The electronics assembly 113 (FIG. 1) in the housing 108 is configured to measure the density of the fluid 114 (FIG. 1) by sensing the amount of time it takes for the ultrasonic wave signal to propagate to, and return from, the first end 116, and sensing the amount of time it takes for the ultrasonic wave signal to propagate to, and return from, the hole 120. The difference between the two elapsed time values may be determined, which is equivalent to the amount of time it takes for the ultrasonic wave signal to propagate and return over the distance 121 between the hole 120 and the first end 116. Because the distance 121 is fully submerged in the fluid 114 (FIG. 1), the calculated propagation time across the distance 121 may be used to further calculate the density of the fluid 114 (FIG. 1) in which the waveguide 110 is partially submerged, taking into account the changes in propagation speed attributable to the separately measured properties of viscosity and temperature of the fluid 114 (FIG. 1).

Referring to FIG. 3, which is an enlarged view of a portion of the sensing segment 119 including the first end 116 of the waveguide 110, a cross-section of the sensing segment 119 may exhibit a non-circular shape. For example, the cross-section of the sensing segment 119 may have a square shape, a triangular shape, a diamond shape, a pentagonal shape, among others. In the embodiment illustrated in FIG. 3, the cross-section of the sensing segment 119 exhibits a cusped diamond shape. The cusped diamond shape may include curved edges 125 that terminate in horizontal points 122 and lateral points 123. The curved edges 125 present a concave outer surface with a radius of curvature that may be larger relative to the height in the Y-direction of the sensing segment 119 cross-section. For example, the horizontal points 122 form vertical edges 127 of the waveguide 110 on opposing horizontal sides of the waveguide 110 and the lateral points 123 form vertical edges 127 of the waveguide 110 on opposing lateral sides of the waveguide 110. The horizontal points 122 are substantially aligned with one another in an X-direction. The lateral points 123 are substantially aligned with one another in a Y-direction. The horizontal points 122 define acute local included angles 142 between the curved edges 125, and extend in vertical edges 127 the vertical length of the sensing segment 119 in the Z-direction.

The cusped diamond cross-section defines a closed quadrilateral that is substantially centrosymmetric and bilaterally symmetric about orthogonal axes (e.g., the X-axis and the Y-axis) in a plane. The cusped diamond includes four apex regions (e.g., the horizontal points 122 and the lateral points 123) disposed at cardinal orientations (e.g., “left,” “right,” “top,” and “bottom” along the X-and Y-axes). The neighboring apex regions (e.g., the horizontal points 122 and the lateral points 123) are joined by the curved edges 125 that are inwardly convex toward a longitudinal axis 138 of the shape. Each of the horizontal points 122 and the lateral points 123 is a cusp (e.g., the meeting point) of two curved edges 125. A height of the cusped diamond may be defined along a horizontal axis (e.g., the Y-axis) between the opposing lateral points 123, and a width may be defined along a lateral axis (e.g., the X-axis) between the opposing horizontal points 122. In some embodiments, the height and width are substantially equal. In other embodiments, such as the embodiment illustrated in FIG. 3, the height is different from the width. The curved edges 125 between neighboring apex regions (e.g., the horizontal points 122 and the lateral points 123) may be defined by circular arcs, elliptical arcs, clothoid/spline segments, or other arcuate constructions that are inwardly convex with respect to the longitudinal axis 138. The local included angle 142 at each apex may be acute (e.g., less than about 90 degrees) or obtuse (e.g., greater than about 90 degrees).

The cusped diamond shape of the waveguide 110, when submerged, presents a large surface area to the fluid 114 (FIG. 1), which will oppose the torque induced when a torsional ultrasonic wave is generated by the driving segment 117. This counter-torque affects the torsional ultrasonic wave propagation, increasing the measurable difference between the propagation speed in the submerged and exposed portions of the waveguide 110. When a torsional ultrasonic wave is induced in the waveguide 110, the cusped diamond shape may meet greater counter-torque from the contacting fluid than, for example, a circular shaped cross-section may experience. The greater difference between the propagation speed in the submerged and exposed portions of the waveguide 110 may result in greater sensitivity of the fluid property measurement system 106.

The waveguide 110 may include a longitudinal cavity 124 that extends through at least a portion of the waveguide 110. Dimensions of the longitudinal cavity 124 may affect the inertial properties of the waveguide 110. The size and shape of the longitudinal cavity 124 relative to the waveguide 110 may be adjusted to change the inertial sensitivity of the waveguide 110. For example, the longitudinal cavity 124 may have a circular cross-sectional shape and may extend through at least a portion of the waveguide 110 towards the second end 118. The size of the longitudinal cavity 124 may be adjusted depending on the application of the waveguide 110. For example, the major dimension 129 (e.g., a width, diameter, apothem, etc.) of the cross-section of the longitudinal cavity 124 may be increased or decreased depending on the properties of the fluid 114 (FIG. 1) being monitored and/or the material of the waveguide 110. The longitudinal cavity 124 may have a cross-sectional shape that is complementary to the cross-sectional shape of the sensing segment 119 of the waveguide 110. For example, the longitudinal cavity 124 may have a cross-sectional shape that is substantially the same as the cross-sectional shape of the sensing segment 119 of the waveguide 110. In other embodiments, the longitudinal cavity 124 may have a different cross-sectional shape than the cross-sectional shape of the sensing segment 119 of the waveguide 110. For example, the cross-sectional shape of the longitudinal cavity 124 may be a square shape, a hexagonal shape, or another shape. In the embodiment illustrated in FIG. 3, the longitudinal cavity 124 has a substantially circular shape. The longitudinal cavity 124 may result in a reduction in the total mass of the sensing segment 119 of the waveguide 110. Reducing the total mass of the sensing segment 119 may change the sensitivity of the sensing segment 119.

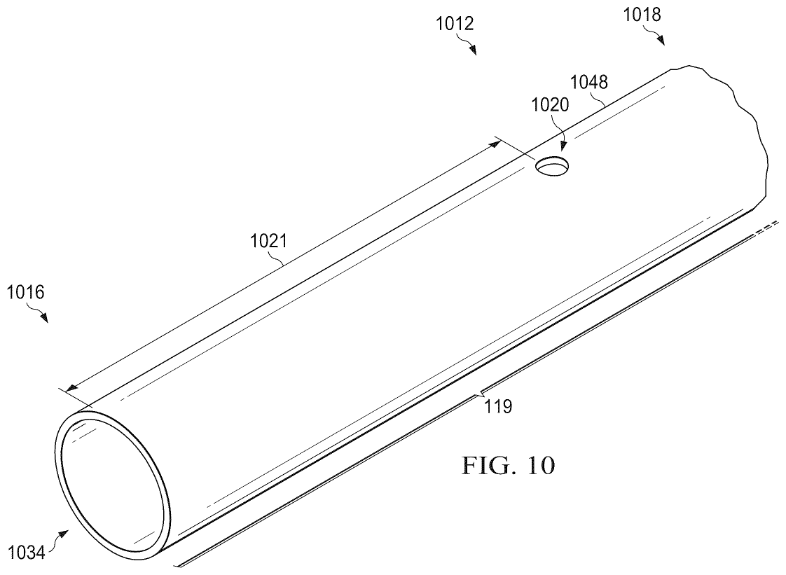

The longitudinal cavity 124 may also be utilized as a space to house one or more additional sensors. For example, a thermocouple (not shown) may be connected from the electronics assembly 113 (FIG. 1) in the housing 108 (FIG. 1) down to the first end 116 of the waveguide 110 where it may make contact with the fluid 114 (FIG. 1) to facilitate temperature measurement. In other embodiments, a pin 136 (e.g., stationary pin 136) may be disposed in the longitudinal cavity 124. The longitudinal cavity 124 may define a space between the walls of the longitudinal cavity 124 and the pin 136, such that the fluid 114 (FIG. 1) is positioned between the pin 136 and the walls of the longitudinal cavity 124. A torsional ultrasonic wave signal passing through the sensing segment 119 of the waveguide 110 may induce movement in the fluid 114 (FIG. 1) relative to the stationary pin 136 (e.g., the pin 136 that does not have a torsional ultrasonic wave signal passing through it). The amount of motion transmitted to the fluid 114 (FIG. 1) between the walls of the longitudinal cavity 124 and the pin 136 may be determined for the measurement of viscosity of the fluid 114 (FIG. 1) between the pin 136 and the walls of the longitudinal cavity 124 of the surrounding waveguide 110. When a torsional ultrasonic wave is generated in the waveguide 110, the thin layer of fluid 114 (FIG. 1) opposes the torque induced by the ultrasonic wave, creating a counter-torque that is proportional to the viscosity of the fluid 114 (FIG. 1). Calculation of the viscosity of the fluid 114 (FIG. 1) may be made with the time measurement for wave propagation between the first end 116 and the hole 120 along with the known distance of travel between the first end 116 and the hole 120, taking into account the change in propagation speed attributable to the separately measured temperature of the fluid 114 (FIG. 1). Additional details regarding the calculation of the viscosity measurement are described below with reference to FIG. 10. Housing temperature sensors (not shown) and/or pins 136 to facilitate the measurement of viscosity in the longitudinal cavity 124 may facilitate the fluid property measurement system 106 (FIG. 1) being able to fit into smaller areas of the energy system 100.

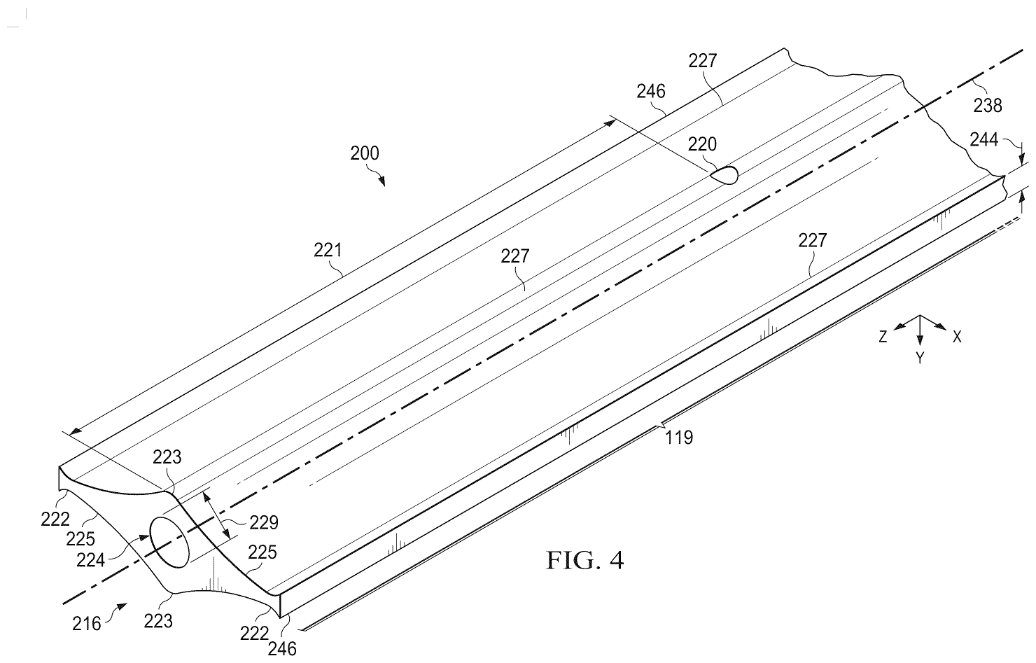

Referring to FIG. 4, which is an enlarged view of a portion of the sensing segment 119. FIG. 4 illustrates the first end 216 of an embodiment of a waveguide 200. A cross-section of the sensing segment 119 may exhibit a non-circular shape. The waveguide 200 includes a first end 216 and a longitudinal cavity 224 extending from the first end 216 into the waveguide 200. The waveguide 200 exhibits a modified cusped diamond shaped cross-section. The modified cusped diamond shape includes fin 246 at opposing vertical edges 227 of the sensing segment 119 substantially aligned with one another in an X-direction. The fins 246 are positioned along the vertical edges 227 associated with the horizontal points 222 of the waveguide 200. As illustrated in FIG. 4, the lateral points 223 do not include (e.g., lack) fins 246. Thus, the fins 246 are not positioned on each of the vertical edges 227 of the waveguide 200. The fins 246 increase the mass concentration located at the furthest positions from a central axis 238 of the waveguide 200 along the length of the sensing segment 119. The fins 246 may have a height 244 that is less than a height defined between the lateral points 223 of the modified cusped diamond shape. The fins 246 may be configured to change the inertial sensitivity of the waveguide 200. The modified cusped diamond shape may include curved edges 225 that terminate in horizontal points 222 and lateral points 223.

The fins 246 and the longitudinal cavity 224 may be configured to at least partially define the inertial sensitivity of the waveguide 200 due to both the increased mass located at the region of the modified cusped diamond shape furthest from the central axis 238 of the sensing segment 119 and due to the decreased mass near the central axis 238 of the sensing segment 119 because of the presence of the longitudinal cavity 224. The size of the longitudinal cavity 224 may be adjusted depending on the application of the waveguide 200. For example, the major dimension 229 (e.g., a width, diameter, apothem, etc.) of the cross-section of the longitudinal cavity 224 may be increased or decreased depending on the properties of the fluid 114 (FIG. 1) being monitored and/or the material of the waveguide 200. The longitudinal cavity 224 may have a cross-sectional shape that is complementary to the cross-sectional shape of the sensing segment 119 or different from the cross-sectional shape of the sensing segment 119 of the waveguide 200. The inertial sensitivity may also be defined by other geometric features affecting the mass distribution of the waveguide 200.

As discussed in more detail with reference to FIG. 3, the longitudinal cavity 224 may also be utilized as a space to house one or more additional sensors (e.g., thermocouple) and/or a pin 136 (FIG. 3) for viscosity measurement. The waveguide 200 may include a hole 220. The hole 220 may be located at a fixed distance from the first end 216 of the sensing segment 119. Similar to the hole 120, shown in FIG. 2, the ultrasonic wave may reflect off of the hole 220. As discussed in more detail with reference to FIG. 2, the time it takes for the ultrasonic wave signal to propagate through the sensing segment 119, with and without a reflection off of the hole 220, may be used along with the known distance 221 between the hole 220 and the first end 216 to calculate the level and density of the fluid 114 (FIG. 1).

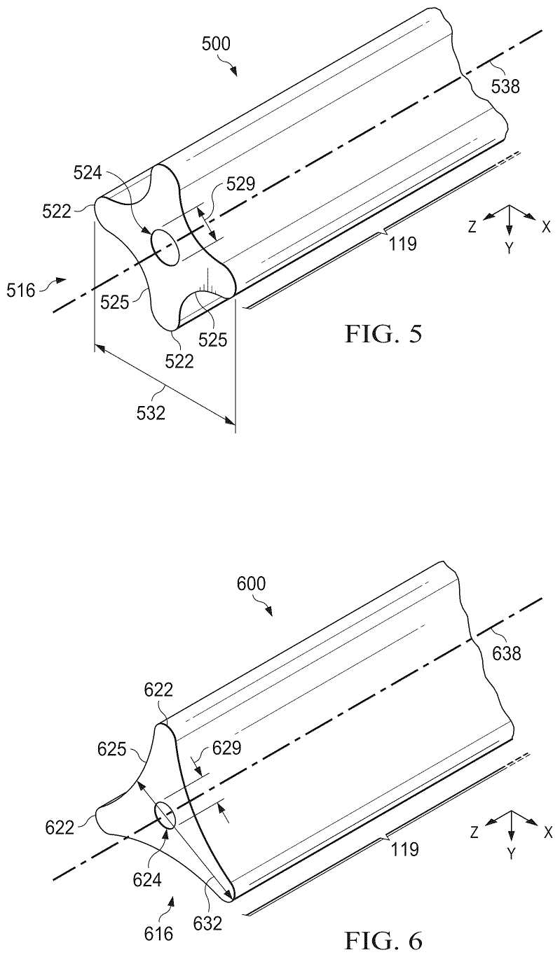

Referring to FIG. 5, another embodiment of a waveguide 500 is shown. The waveguide 500 includes a first end 516 of the sensing segment 119 and may include a longitudinal cavity 524 extending from the first end 516 into the waveguide 500. The longitudinal cavity 524 has a major dimension 529 defining the opening of the longitudinal cavity 524. The sensing segment 119 of the waveguide 500 exhibits a cruciform shaped cross-section. The cruciform shape may include tips 522 and an outer edge 525. The tips 522 are disposed at cardinal orientations (e.g., “left,” “right,” “top,” and “bottom” along the X- and Y-axes) of the cruciform shaped cross-section and form the furthest outlying portions from a central axis 538 of the sensing segment 119. The tips 522 may lie substantially equidistant from the central axis 538 of the cruciform shaped cross-section. The outer edge 525 forms the outer boundary of the cruciform shaped cross-section and includes alternating concave and convex sections with respect to the central axis 538 of the cruciform shaped cross-section. The sections of the outer edge 525 that are internally convex with respect to the central axis 538 of the cruciform shaped cross-section may have a greater radius of curvature than the sections of the outer edge 525 that are internally concave with respect to the central axis 538 of the cruciform shaped cross-section.

The cruciform shape includes a closed shape that is substantially centrosymmetric and bilaterally symmetric about orthogonal axes (e.g., the X-axis and the Y-axis) in a plane, having four substantially identical lobes/arms/quadrants that are oriented at 90-degree intervals, such that the shape is invariant under 90-degree rotation about its central axis 538. The cruciform shape includes four tips 522 disposed at cardinal orientations (e.g., “left,” “right,” “top,” and “bottom” along the X-and Y-axes), with the tips 522 bounded by sections of the outer edge 525 that are inwardly concave with respect to the central axis 538 of the cruciform shape. The tips 522 are joined by the respective sections of the outer edge 525. A span dimension 532 of the cruciform shape may be defined along both a lateral axis (e.g., the X-axis) and a longitudinal axis (e.g., the Y-axis) between a pair of opposite tips 522, with the span dimension 532 being substantially equivalent whether measured between opposite tips 522 in either the lateral or longitudinal axes. The inwardly convex outer edge 525 sections between neighboring tips 522 may be defined by circular arcs, elliptical arcs, clothoid/spline segments, or other arcuate constructions that are inwardly convex with respect to the central axis 538. The inwardly concave outer edge 525 sections defining each tip 522 may be defined by circular arcs, elliptical arcs, clothoid/spline segments, or other arcuate constructions that are inwardly concave with respect to the central axis 538. In other embodiments, the cruciform shape may include variants in which the outer edge 525 sections include short linear facets that approximate an arcuate profile, provided the overall shape remains generally cruciform-like with alternating inwardly concave sections and inwardly convex sections, with four tips 522 aligned to the orthogonal axes.

The radius of curvature at each tip 522 may, in some embodiments, be increased such that the transition between inwardly convex and inwardly concave sections of the outer edge 525 may be located further from the central axis 538, and the inwardly concave portion of the outer boundary may form a swelled lobe with increased area. The resulting increased area at each tip 522 and the presence of the longitudinal cavity 524 may increase the inertial sensitivity of the waveguide 500 due to both the increased mass located at the tips 522, which are located furthest from the central axis 538 of the sensing segment 119, and due to the decreased mass near the central axis 538 of the sensing segment 119. Other geometric changes to the mass distribution of the waveguide 500 may be implemented to change the inertial sensitivity of the sensing segment 119.

As discussed in more detail with reference to FIG. 3, the size and shape of the longitudinal cavity 524 relative to the waveguide 500 may be adjusted to change the inertial sensitivity of the waveguide 500. Additionally, as discussed in more detail with reference to FIG. 3, the longitudinal cavity 524 may be utilized as a space to house one or more additional sensors (e.g., thermocouple) and/or a pin 136 (FIG. 3) for viscosity measurement. The sensing segment 119 of the waveguide 500 may include a hole 120, 220 (FIGS. 2 and 4). The hole 120, 220 may be located at a fixed distance from the first end 516 of the sensing segment 119. Similar to the hole 120, shown in FIG. 2, the ultrasonic wave may reflect off of the hole 120, 220 that may also be included in waveguide 500. As discussed in more detail with reference to FIG. 2, the time it takes for the ultrasonic wave signal to propagate through the sensing segment 119, with and without a reflection off of the hole 120, 220, may be used to calculate the level and density of the fluid 114 (FIG. 1).

Referring to FIG. 6, another embodiment of a waveguide 600 is shown. The waveguide 600 includes a first end 616 of the sensing segment 119 and may include a longitudinal cavity 624 extending from the first end 616 into the waveguide 600. The longitudinal cavity 624 has a major dimension 629 defining the opening of the longitudinal cavity 624. The sensing segment 119 of the waveguide 600 exhibits a trefoil shaped cross-section. The trefoil shape may include tips 622 and an outer edge 625. The tips 622 are disposed at a substantially equidistant angle from one another about the central axis 638 of the trefoil shaped cross-section and form the furthest outlying portions from the central axis 638 of the sensing segment 119. The tips 622 may lie substantially equidistant from a central axis 638 of the trefoil shaped cross-section. The outer edge 625 forms the outer boundary of the trefoil shaped cross-section and consists of alternating concave and convex sections with respect to the central axis 638 of the cruciform shaped cross-section. The sections of the outer edge 625 that are internally convex with respect to the central axis 638 of the cruciform shaped cross-section may have a greater radius of curvature than the sections of the outer edge 625 that are internally concave with respect to the central axis 638 of the cruciform shaped cross-section.

The trefoil shape includes a closed shape that is substantially centrosymmetric and trilaterally symmetric about lines of symmetry separated by 120 degrees, having three substantially identical lobes/arms/sectors that are oriented at 120-degree intervals, such that the shape is invariant under 120-degree rotation about its central axis 638. The trefoil shape includes three tips 622 disposed at 120-degree intervals about the central axis 638, with the tips 622 bounded by sections of the outer edge 625 that are inwardly concave with respect to the central axis 638 of the trefoil shape. The tips 622 are joined by the respective sections of the outer edge 625 that are inwardly convex with respect to the central axis 638 of the trefoil shape. A chord dimension 632 of the trefoil shape may be defined between each tip 622 and the opposing outer boundary of each tip 622, which lies between the other remaining tips 622. The chord dimension 632 may be substantially equivalent between all tips 622 and the respective opposing outer boundary pair. The inwardly convex outer edge 625 sections between neighboring tips 622 may be defined by circular arcs, elliptical arcs, clothoid/spline segments, or other arcuate constructions that are inwardly convex with respect to the central axis 638. The inwardly concave outer edge 625 sections defining each tip 622 may be defined by circular arcs, elliptical arcs, clothoid/spline segments, or other arcuate constructions that are inwardly concave with respect to the central axis 638. In other embodiments, a trefoil shape may include variants in which the outer edge 625 sections include short linear facets that approximate an arcuate profile, provided the overall shape remains generally trefoil-like with alternating inwardly concave sections and inwardly convex sections, with three tips 622 disposed at 120-degree intervals about the central axis 638.

The radius of curvature at each tip 622 may, in some embodiments, be increased such that the transition between inwardly convex and inwardly concave sections of the outer edge 625 may be located further from the central axis 638, and the inwardly concave portion of the outer boundary may form a swelled lobe with increased area. The resulting increased arca at each tip 622 and the presence of the longitudinal cavity 624 increase the inertial sensitivity of the waveguide 600 due to both the increased mass located at the tips 622, which are located furthest from the central axis 638 of the sensing segment 119, and due to the decreased mass near the central axis 638 of the sensing segment 119. Other geometric changes to the mass distribution of the waveguide 600 may be implemented to change the inertial sensitivity of the sensing segment 119.

As discussed in more detail with reference to FIG. 3, the size and shape of the longitudinal cavity 624 relative to the waveguide 600 may be adjusted to change the inertial sensitivity of the waveguide 600. Additionally, as discussed in more detail with reference to FIG. 3, the longitudinal cavity 624 may be utilized as a space to house one or more additional sensors (e.g., thermocouple) and/or a pin 136 (FIG. 3) for viscosity measurement. The sensing segment 119 of the waveguide 600 may include a hole (e.g., hole 120, 220 (FIGS. 2 and 4)). The hole 120, 220 may be located at a fixed distance from the first end 616 of the sensing segment 119. Similar to the hole 120, shown in FIG. 2, the ultrasonic wave may reflect off the hole to separately calculate the level and density of the fluid 114 (FIG. 1).

Referring to FIG. 7, the driving segment 117 of the waveguide 700 may include driving elements 731 configured to generate an ultrasonic wave signal in the waveguide 700 and/or the sheath 112 (FIG. 1). The driving elements 731 may include a magnetostrictive strip 726 and a piezoelectric crystal 728. The magnetostrictive strip 726 and the piezoelectric crystal 728 are configured to operate with a receiver 730 operatively connected to the electronics assembly 113 (FIG. 1) housed in a housing 708 of the fluid property measurement system 106 to generate an ultrasonic wave in the waveguide 700. The ultrasonic wave type produced by the driving elements 731 may be a torsional wave, longitudinal wave, shear wave, or flexural wave type. The receiver 730 is configured to receive a signal from the electronics assembly 113 (FIG. 1) of the housing 708 to activate one or more driving elements 731 to generate the ultrasonic wave in the waveguide 700. The receiver 730 is also configured to detect input from the driving element 731 responsive to the return of reflected ultrasonic waves in the waveguide 700 and/or the sheath 112 (FIG. 1) and to send a signal to the electronics assembly 113 (FIG. 1), which may be housed in the housing 708 of the fluid property measurement system 106 after the ultrasonic wave has reflected off the first end 116 or hole 120 of the waveguide 700 one or more times. The electronics assembly 113 (FIG. 1) may record and/or calculate the time between generation and detection of ultrasonic wave signals.

FIG. 7 depicts a waveguide 700 with both magnetostrictive strip 726 and piezoelectric crystal 728 driving elements 731 in a hybrid drive arrangement. In such a hybrid arrangement, the driving elements 731, upon receiving instructions via an electronic communication signal from the electronics assembly 113 (FIG. 1) via the receiver 730, induce the ultrasonic wave signal by activating either in concert or independently.

Magnetostrictive materials exhibit changes in dimension under changes to or application of magnetic fields (i.e., the magnetostrictive effect). This change in dimension may be used to exert a force on contiguous structures and may be used to induce (e.g., generate) an acoustic wave signal in contiguous structures. The inverse effect (i.e., the Vallari effect), where an external force is exerted on the magnetostrictive strip 726 to produce a change in local magnetic field properties, may be measured and used to sense the presence and properties of such forces. As depicted in FIG. 7, the magnetostrictive strips 726 may be arranged in a helical pattern about the central axis 738 of the driving segment 117 of the waveguide 700. A brazing process may be used to affix the magnetostrictive strips 726 to the body of the waveguide 700. The helical arrangement of the magnetostrictive strips 726 may promote a twisting force, configured to induce a torsional ultrasonic wave in the sensing segment 119. In addition to the helical arrangement of the magnetostrictive strips 726, helical gaps 733 located between the magnetostrictive strips 726 may be proportioned to promote the desired pattern of expansion and contraction of the magnetostrictive strips 726 during activation, promoting generation of the desired ultrasonic wave signal. As described in further detail above with respect to FIG. 2 and FIG. 3, torsional ultrasonic waves are particularly used in the fluid property measurement system 106 (FIG. 1) to determine the level, density, and/or viscosity of the fluid 114 (FIG. 1).

Piezoelectric crystals 728 exhibit changes in dimension under application of electrical energy (i.e., the inverse piezoelectric effect). This change in dimension may be used to exert a force on contiguous structures and may be used to induce (e.g., generate) an acoustic wave signal in contiguous structures. The inverse effect (i.e., the piezoelectric effect), where an external force is exerted on the piezoelectric crystal 728 to produce electrical energy, may be measured and used to sense the presence and properties of such forces. As depicted in FIG. 7, the piezoelectric crystal 728 may have a substantially cylindrical shape and may be arranged coaxially with the waveguide 700 on the second end 718. This arrangement may be employed to generate longitudinal waves in the sensing segment 119 of the waveguide 700. As described in further detail below with respect to FIG. 10, longitudinal ultrasonic waves are used in the fluid property measurement system 106 (FIG. 1) to determine the temperature of the fluid 114 (FIG. 1).

An ultrasonic wave may be generated by an electrical signal from the electronics assembly 113 (FIG. 1) and may pass to or around the driving elements 731 (e.g., the magnetostrictive strip 726 and/or the piezoelectric crystals 728), whichever is present on the waveguide 700 or sheath 112 (FIG. 1). In some embodiments, the driving segment 117 may include one or more driving elements 731 to facilitate conversion of the electric signal from the electronics assembly 113 (FIG. 1) to the ultrasonic wave in the waveguide 700 and/or the sheath 112 (FIG. 1). After the electrical signal is converted into an ultrasonic wave in the sensing segment 119, the ultrasonic wave may propagate longitudinally along the waveguide 700 and/or sheath 112 (FIG. 1). The ultrasonic wave may propagate along the entire length of the sensing segment 119 and reflect back to the second end 718. When the ultrasonic wave passes back over the magnetostrictive strip 726 and/or piezoelectric crystals 728, the receiver 730 may send an electrical signal to the electronics assembly 113 (FIG. 1) to facilitate measurement of the time between initially sending the ultrasonic wave and detection or propagation of the ultrasonic wave between the first end 116 (FIG. 2) and second end 718 of the waveguide 700.

In some embodiments, the electronics assembly 113 (FIG. 1) may be configured to send signals facilitating formation of different types of waves in the waveguide 700 and the sheath 112 (FIG. 1). For example, the signal sent by the electronics assembly 113 (FIG. 1) may cause torsional and/or shear ultrasonic waves to be generated in the waveguide 700 and the sheath 112 (FIG. 1). The ultrasonic waves may exhibit a range of frequencies, such as from about 20 Hz to about 1 MHz.

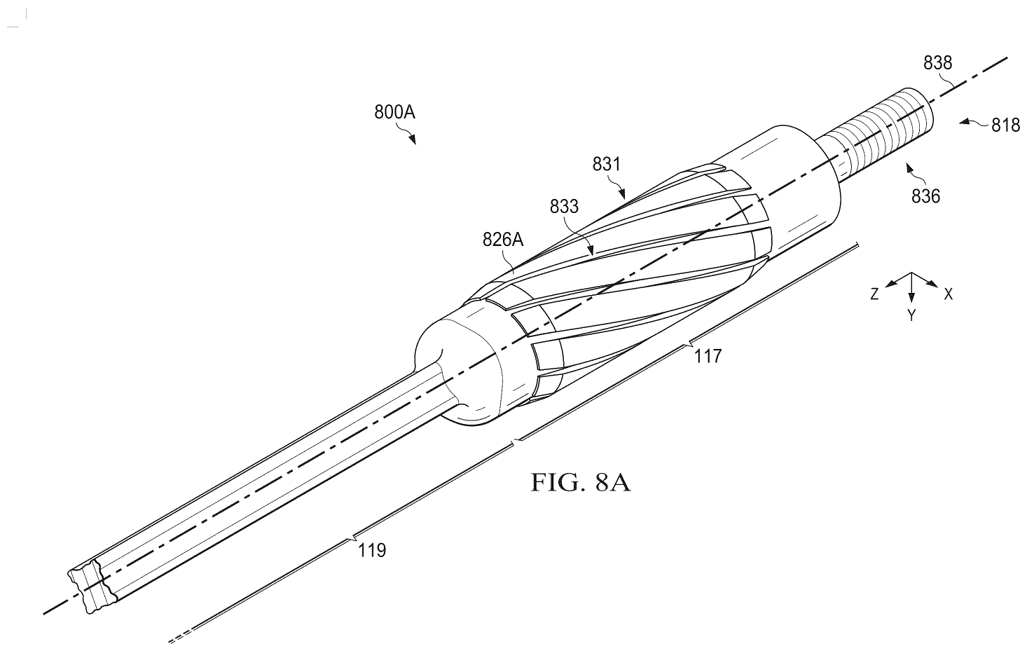

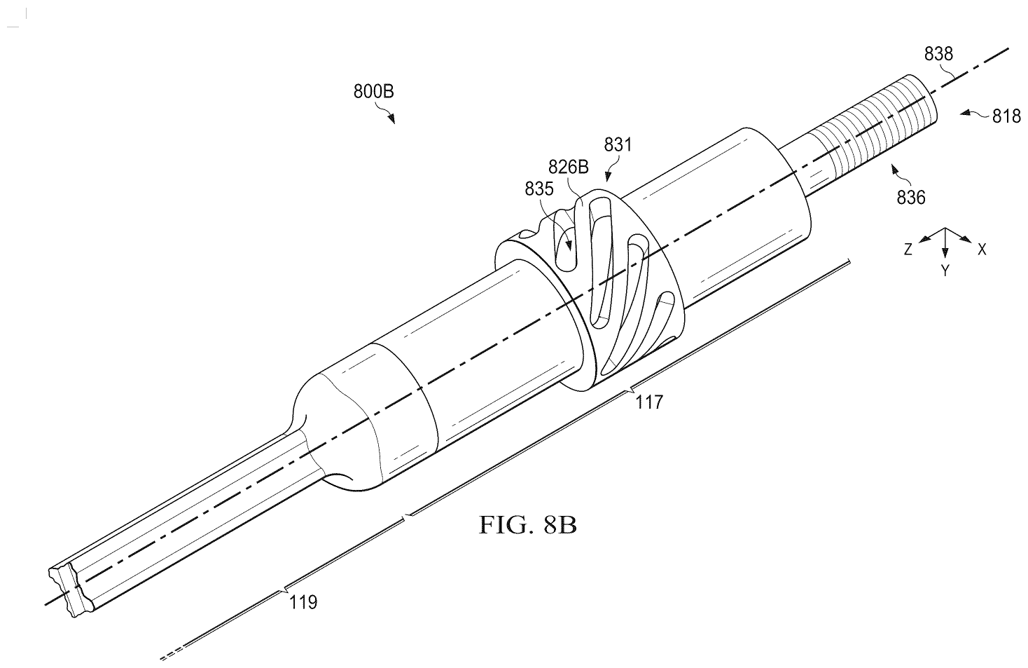

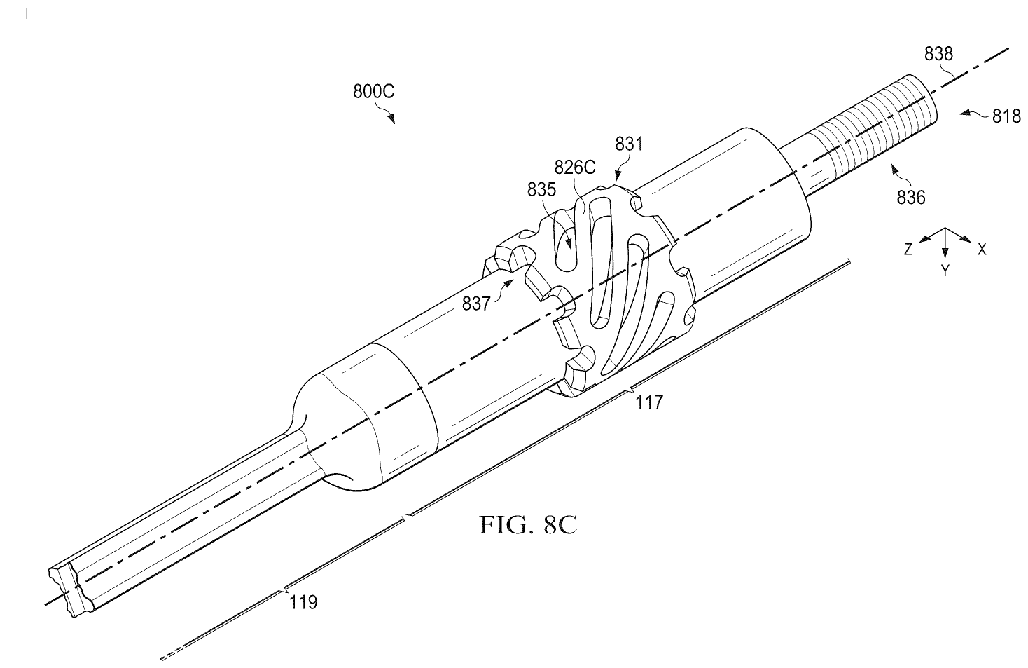

In other embodiments, as depicted in FIGS. 8A, 8B, and 8C, the driving elements 731 may include one or more magnetostrictive strips 726, without piezoelectric crystals 728 to induce the ultrasonic wave signals. In still other embodiments, as depicted in FIG. 9, the driving elements 731 may include one or more piezoelectric crystals 728, without magnetostrictive strips 726 to induce the ultrasonic wave signals. In yet other embodiments, other types of driving elements 731 beyond magnetostrictive strips 726 and piezoelectric crystals 728, such as electrostrictives, may be utilized, alone or in concert with magnetostrictive strips 726 and/or piezoelectric crystals 728, to induce acoustic wave signals of different types (e.g., torsional waves, longitudinal waves, shear waves, flexural waves, etc., in ultrasonic and/or subsonic frequencies) in the sensing segment 119 of the waveguide 700.

Referring to FIG. 8A, the driving segment 117 of the waveguide 800A may include driving elements 831 configured to generate an ultrasonic wave signal in the waveguide 800A. The driving elements 831 may include magnetostrictive strips 826A. The magnetostrictive strips 826A are configured to operate with a receiver 730 operatively connected to the electronics assembly 113 (FIG. 1) in the housing 108 (FIG. 1) to generate an ultrasonic wave in the waveguide 800A and/or the sheath 112 (FIG. 1). The ultrasonic wave type produced by the magnetostrictive strips 826A may be a torsional wave, longitudinal wave, shear wave, or flexural wave. The receiver 730 is configured to receive a signal from the electronics assembly 113 (FIG. 1) of the housing 108 (FIG. 1) to activate one or more driving elements 831 to generate the ultrasonic wave in the waveguide 800A. The receiver 730 is also configured to detect input from the driving element 831 triggered by the return of reflected ultrasonic waves in the sensing segment 119 and to send a signal to the electronics assembly 113 (FIG. 1) of the housing 108 (FIG. 1) after the ultrasonic wave has reflected off the first end 116 or hole 120 of the waveguide 800A one or more times. The electronics assembly 113 (FIG. 1) may calculate and/or record the time between generation and detection of ultrasonic wave signals.

FIG. 8A shows a waveguide 800A with driving elements 831 comprising magnetostrictive strips 826A. The magnetostrictive strips 826A, upon receiving instructions via an electronic communication signal from the electronics assembly 113 (FIG. 1) via the receiver 730, induce the commanded ultrasonic wave signal, with each magnetostrictive strip 826A activating in a coordinated fashion with one another. As depicted in FIG. 8A, the magnetostrictive strips 826A are arranged in a helical pattern about the central axis 838 of the driving segment 117 of the waveguide 800A. This arrangement may generate a twisting force, capable of inducing a torsional ultrasonic wave in the sensing segment 119. In addition to the helical arrangement of the magnetostrictive strips 826A, helical gaps 833 located between the magnetostrictive strips 826A may be proportioned to promote the desired pattern of expansion and contraction of the magnetostrictive strips 826A during activation, promoting generation of the desired ultrasonic wave signal in the waveguide 800A. As described in further detail above with respect to FIG. 2 and FIG. 3, torsional ultrasonic waves are used in the fluid property measurement system 106 (FIG. 1) to determine the level, density, and/or viscosity of the fluid 114 (FIG. 1).

The driving segment 117 of the waveguide 800A also includes a magnet bank 836 formed at the second end 818 of the waveguide 800A from a series of stacked magnets configured to generate longitudinal waves in the sensing segment 119 of the waveguide 800A. The magnets of the magnet bank 836 are arranged to be substantially coaxial with the waveguide 800A. The magnet bank 836 is a driving element 831 that may generate longitudinal waves in the sensing segment 119 of the waveguide 800A. As described in further detail below with respect to FIG. 10, longitudinal ultrasonic waves are used in the fluid property measurement system 106 (FIG. 1) to determine the temperature of the fluid 114 (FIG. 1). The magnet bank 836 may act in concert with the magnetostrictive strips 826A, or independently, to generate ultrasonic waves in the sensing segment 119 upon activation by the electronics assembly 113 (FIG. 1) through the receiver 730 (FIG. 7).

Referring to FIG. 8B, the driving segment 117 of the waveguide 800B may include driving elements 831 configured to generate an ultrasonic wave signal in the waveguide 800B. The driving elements 831 may include a magnetostrictive collar 826B. The magnetostrictive collar 826B is configured to operate with the receiver 730 operatively connected to the electronics assembly 113 (FIG. 1) in the housing 108 (FIG. 1) to generate an ultrasonic wave in the waveguide 800B and/or the sheath 112 (FIG. 1). The ultrasonic wave type produced by the magnetostrictive collar 826B may be a torsional wave, longitudinal wave, shear wave, or flexural wave. The receiver 730 is configured to receive a signal from the electronics assembly 113 (FIG. 1) of the housing 108 (FIG. 1) to activate a magnetostrictive collar 826B to generate the ultrasonic wave in the waveguide 800B. The receiver 730 is also configured to detect input from the magnetostrictive collar 826B triggered by the return of reflected ultrasonic waves in the sensing segment 119 and to send a signal to the electronics assembly 113 (FIG. 1) of the housing 108 (FIG. 1) after the ultrasonic wave has reflected off the first end 116 or hole 120 of the waveguide 800B one or more times. The electronics assembly 113 (FIG. 1) may calculate and/or record the time between generation and detection of ultrasonic wave signals.

FIG. 8B shows a waveguide 800B with driving elements 831 comprising a magnetostrictive collar 826B. The magnetostrictive collar 826B may have case of assembly advantages, as it slides on or around the driving segment 117, when compared to some other embodiments of driving elements 831. The magnetostrictive collar 826B, upon receiving instructions via an electronic communication signal from the electronics assembly 113 (FIG. 1) via the receiver 730, may induce the commanded ultrasonic wave signal, with the magnetostrictive collar 826B activating in a coordinated fashion with any other driving element 831, if present. As depicted in FIG. 8B, the magnetostrictive collar 826B is located coaxially with the central axis 838 of the driving segment 117 of the waveguide 800B. The arrangement in the magnetostrictive collar 826B of magnetostrictive materials and helical slots 835 is configured to generate a twisting force, capable of inducing a torsional ultrasonic wave in the sensing segment 119. The disposition and number of helical slots 835 located throughout the magnetostrictive material of the magnetostrictive collar 826B may be changed to promote the desired pattern of expansion and contraction of the magnetostrictive collar 826B during activation, thereby promoting generation of the desired ultrasonic wave signal in the waveguide 800B. As described in further detail above with respect to FIG. 2 and FIG. 3, torsional ultrasonic waves are used in the fluid property measurement system 106 (FIG. 1) to determine the level, density, and/or viscosity of the fluid 114 (FIG. 1).

The driving segment 117 of the waveguide 800B includes a magnet bank 836 formed at the second end 818 of the waveguide 800B of a series of stacked magnets configured to generate longitudinal waves in the sensing segment 119 of the waveguide 800B. The magnet bank 836 is a driving element 831 that may generate longitudinal waves in the sensing segment 119 of the waveguide 800B. As described in further detail below with respect to FIG. 10, longitudinal ultrasonic waves are used in the fluid property measurement system 106 (FIG. 1) to determine the temperature of the fluid 114 (FIG. 1). The magnet bank 836 may act in concert with the magnetostrictive collar 826B, or independently, to generate ultrasonic waves in the sensing segment 119 upon activation by the electronics assembly 113 (FIG. 1) through the receiver 730 (FIG. 7).

Referring to FIG. 8C, the driving segment 117 of the waveguide 800C may include driving elements 831 configured to generate an ultrasonic wave signal in the waveguide 800C. The driving elements 831 may include a magnetostrictive band 826C. The magnetostrictive band 826C is configured to operate with the receiver 730 operatively connected to the electronics assembly 113 (FIG. 1) in the housing 108 (FIG. 1) to generate an ultrasonic wave in the waveguide 800C and/or the sheath 112 (FIG. 1). The ultrasonic wave type produced by the magnetostrictive band 826C may be a torsional wave, longitudinal wave, shear wave, or flexural wave. The receiver 730 is configured to receive a signal from the electronics assembly 113 (FIG. 1) of the housing 108 (FIG. 1) to activate a magnetostrictive band 826C to generate the ultrasonic wave in the waveguide 800C. The receiver 730 is also configured to detect input from the magnetostrictive band 826C triggered by the return of reflected ultrasonic waves in the sensing segment 119 and to send a signal to the electronics assembly 113 (FIG. 1) of the housing 108 (FIG. 1) after the ultrasonic wave has reflected off the first end 116 or hole 120 of the waveguide 800C one or more times. The electronics assembly 113 (FIG. 1) may calculate and/or record the time between generation and detection of ultrasonic wave signals.

FIG. 8C shows a waveguide 800C with driving elements 831 comprising the magnetostrictive band 826C. The magnetostrictive band 826C may have case of assembly advantages, as it slides on or around the driving segment 117, when compared to some other embodiments of driving elements 831. The magnetostrictive band 826C, upon receiving instructions via an electronic communication signal from the electronics assembly 113 (FIG. 1) via the receiver 730, may induce the commanded ultrasonic wave signal, with the magnetostrictive band 826C activating in a coordinated fashion with any other driving clement 831, if present. As depicted in FIG. 8C, the magnetostrictive band 826C is located coaxially with the central axis 838 of the driving segment 117 of the waveguide 800C. The arrangement in the magnetostrictive band 826C of magnetostrictive materials, helical slots 835, and edge gaps 837 facilitate the generation of twisting forces, capable of inducing a torsional ultrasonic wave in the sensing segment 119, and longitudinal forces, capable of inducing a longitudinal ultrasonic wave in the sensing segment 119. The disposition and number of helical slots 835 and edge gaps 837 located throughout the magnetostrictive material of the magnetostrictive band 826C may be changed to promote the desired pattern of expansion and contraction of the magnetostrictive band 826C during activation, promoting generation of the desired ultrasonic wave signal in the waveguide 800C. As described in further detail above with respect to FIG. 2 and FIG. 3, torsional ultrasonic waves are used in the fluid property measurement system 106 (FIG. 1) to determine the level and density of the fluid 114 (FIG. 1). As described in further detail below with respect to FIG. 10, longitudinal ultrasonic waves are used in the fluid property measurement system 106 (FIG. 1) to determine the temperature of the fluid 114 (FIG. 1).

The driving segment 117 of the waveguide 800C includes a magnet bank 836 formed at the second end 818 of the waveguide 800C of a series of stacked magnets configured to generate longitudinal waves in the sensing segment 119 of the waveguide 800C. The magnet bank 836 is a driving element 831 that may generate longitudinal waves in the sensing segment 119 of the waveguide 800C. As described in further detail below with respect to FIG. 10, longitudinal ultrasonic waves are used in the fluid property measurement system 106 (FIG. 1) to determine the temperature of the fluid 114 (FIG. 1). The magnet bank 836 may act in concert with the magnetostrictive band 826C, or independently, to generate ultrasonic waves in the sensing segment 119 upon activation by the electronics assembly 113 (FIG. 1) through the receiver 730 (FIG. 7).

Referring to FIG. 9, the driving segment 117 of the waveguide 900 may include multiple driving elements 931. In some embodiments, the driving elements 931 may include a longitudinal piezoelectric crystal 940, extending from the second end 912, oriented coaxially with the central axis 938 of the driving segment 117 of the waveguide 900 and one or more lateral piezoelectric crystals 942 oriented perpendicular to a central axis 938 of the driving segment 117. The driving elements 931 are configured to operatively connect to the electronics assembly 113 (FIG. 1) in the housing 108 (FIG. 1). The electronics assembly 113 (FIG. 1) may be able to transmit torsional, longitudinal, flexural, or shear ultrasonic waves to the waveguide 900 through the longitudinal piezoelectric crystal 940 or lateral piezoelectric crystal 942.

As depicted in FIG. 9, the longitudinal piezoelectric crystals 940 may have a substantially cylindrical shape and may be arranged coaxially with the driving segment 117. This arrangement may be configured to generate longitudinal waves in the sensing segment 119 of the waveguide 900. As described in further detail below with respect to FIG. 10, longitudinal ultrasonic waves are used in the fluid property measurement system 106 (FIG. 1) to determine the temperature of the fluid 114 (FIG. 1). The lateral piezoelectric crystals 942 may have a substantially cylindrical shape and may be arranged perpendicular to the central axis 938 of the driving segment 117. This arrangement may be employed to generate shear waves in the sensing segment 119 of the waveguide 900.

The driving segments 117 of waveguide-structures may take many forms, including the forms of any of the exemplary designs found in FIGS. 7-9. These driving segments 117 may be paired with a variety of sensing segment 119 designs, which may take many forms, including the forms of any of the exemplary designs found in FIGS. 3-6, to form various waveguide-structures with attributes suitable to measuring fluid properties in different environmental contexts. This may facilitate design flexibility, which may provide advantages as new applications for the fluid property measurement system 106 (FIG. 1) arise.

FIG. 10 illustrates a sensing segment 119 of a sheath 1012, similar to the sheath 112 (FIG. 1) of the energy system 100 (FIG. 1). The first end 1016 of the sheath 1012 may define a central cavity 1034 therethrough. The central cavity 1034 may have a substantially circular cross-section defined by a wall 1048. In some embodiments, the central cavity 1034 may exhibit another cross-sectional shape such as a square cross-sectional shape, a triangular cross-sectional shape, an oval cross-sectional shape, or some combination thereof. The central cavity 1034 may be sized and shaped to at least partially surround the sensing segment 119 of the waveguide (e.g., waveguide 110, 200, 500, 600 (FIGS. 1-6)). Nesting the waveguide within the sheath 1012 may facilitate fitting the fluid property measurement system 106 (FIG. 1) into smaller areas of the energy system 100. In some embodiments, the sheath 1012 is configured to provide physical protection to the nested waveguide, such as to protect the nested waveguide from physical contact with internal structures of the associated equipment during operation and/or during installation or removal.

The second end 1018 of the sheath 1012 may include a driving segment 117 similar to the driving segments 117 shown in FIGS. 7-9. The driving segment 117 associated with the sheath 1012 may include driving elements 731, 831, 931 configured to generate a shear, torsional, longitudinal, and/or flexural ultrasonic wave signal when activated by the receiver 730, which is configured to receive a signal from the electronics assembly 113 (FIG. 1) of the housing 108 (FIG. 1). The receiver 730 is also configured to detect input from the driving elements 731, 831, 931 responsive to the return of reflected ultrasonic waves in the sensing segments 119 of the waveguide 110, 200, 500, 600 and/or the sheath 1012 and to send a signal to the electronics assembly 113 of the housing 108 (FIG. 1) after the ultrasonic wave has reflected off the first end 1016 of the waveguide 110, 200, 500, 600 and/or first end 1016 of the sheath 1012 one or more times. The electronics assembly 113 may record and/or calculate the time between generation and detection of ultrasonic waves. Similarly to the waveguide 110, 200, 500, 600, the sheath 1012 may include a hole 1020. The hole 1020 may be located at a distance 1021 from the first end 1016 of the sheath 1012. The distance 1021 may be defined, such that the hole 1020 remains submerged in the fluid 114 (FIG. 1). The ultrasonic wave may travel along the length of the sheath 1012 to the first end 1016 and reflect back to the second end 1018 and into the housing 108 (FIG. 1). When the ultrasonic wave signal travels through the sheath 1012 from the second end 1018, a portion of the ultrasonic wave signal reflects from the first end 1016 of the sheath 1012. A complementary portion of the ultrasonic wave signal reflects from the hole 1020. As similarly described above with respect to FIG. 2, the electronics assembly 113 in the housing 108 (FIG. 1) is configured to measure the time it takes for the wave to propagate along the sheath 1012 including no reflections off the hole 1020 and one or more reflections off the hole 1020. When the hole 1020 is submerged within the fluid 114 (FIG. 1), it is possible to measure the time it takes for the wave to propagate the distance 1021 along the portion of the sheath 1012 between the first end 1016 and the hole 1020.

The thin layer of fluid found between the waveguide 110, 200, 500, 600 and the surrounding sheath 1012 facilitates the measurement of viscosity. When a torsional ultrasonic wave is generated in the sheath 1012, the thin layer of fluid 114 (FIG. 1) opposes the torque induced in the sheath 1012, creating a counter-torque that is proportional to the viscosity of the fluid 114 (FIG. 1). Calculation of the viscosity of the fluid 114 (FIG. 1) may be made with the time measurement for wave propagation between the first end 1016 and the hole 1020 along with the distance 1021 of travel between the first end 1016 and the hole 1020, taking into account the change in propagation speed attributable to the separately measured temperature of the fluid 114 (FIG. 1).

Temperature measurement in the fluid property measurement system 106 (FIG. 1) may be achieved by several different methods. Unlike torsional ultrasonic waves, longitudinal ultrasonic waves are less affected by variations in the level, density, and viscosity of the fluid 114 (FIG. 1) being measured. Longitudinal ultrasonic waves may be measured independently from torsional waves and may be generated in the waveguide 110, 200, 500, 600 or sheath 1012 using one or more of the driving elements 731, 831, 931 (e.g., the magnetostrictive strip 726 and/or the piezoelectric crystal 728, 940, 942) activated by the receiver 730 configured to receive a signal from the electronics assembly 113 (FIG. 1) of the housing 108 (FIG. 1). By measuring the elapsed time between generation of the ultrasonic wave at the second end 118, 912, 1018 and detection of the reflected ultrasonic wave back at the second end 118, 912, 1018, the temperature of the waveguide 110, 200, 500, 600 or sheath 1012 may be calculated using the total distance of travel of the ultrasonic wave.

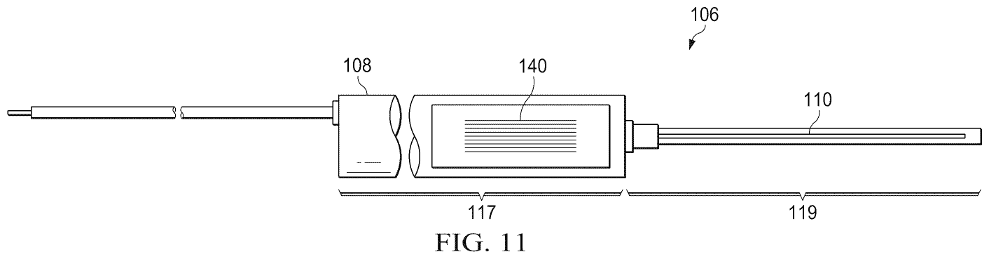

Referring to FIG. 11, the fluid property measurement system 106 may optionally include at least one dedicated temperature measurement device 140, such as a thermocouple. The temperature measurement device 140 may be located in the housing 108 and may be operatively connected to the waveguide 110. In some embodiments, the temperature measurement device 140 may be housed in the longitudinal cavity 124, 224, 524, 624 as discussed with respect to FIGS. 3-6. The temperature measurement device 140 may be configured to collect temperature data of the waveguide 110, 200, 500, 600. The temperature of the waveguide 110, 200, 500, 600 may affect the time it takes for ultrasonic waves to propagate through the waveguide 110, 200, 500, 600. Accordingly, the calculations for determining the level of the fluid 114 (FIG. 1), the density of the fluid 114 (FIG. 1), and the viscosity of the fluid 114 (FIG. 1) may be affected by the temperature of the waveguide 110, 200, 500, 600, such that a temperature correction may be beneficial to include in the calculation. Therefore, an independent, simultaneous reading of temperature of the waveguide 110, 200, 500, 600 may be used as part of a temperature correction component when calculating the level, density, and viscosity of the fluid 114 (FIG. 1) to prevent skewed data.

In another exemplary embodiment, the fluid property measurement system 106 may be used to determine one or more of temperature, fluid level, density, and viscosity of other fluids, such as liquid plastics, during plastics manufacturing processes. The temperature, fluid level, density, and viscosity of the fluid may be determined substantially simultaneously by a single fluid property measurement system 106. Determining one or more of temperature, fluid level, density, and viscosity of liquid plastics during manufacturing processes, such as heating, cooling, mixing, compounding, polymerizing, isomerizing, reacting, transporting, molding, or extrusion, may facilitate better process control. Fluid property data may be input into a control feedback loop for the adjustment and fine tuning of manufacturing system parameters to achieve desired output characteristics.

In another exemplary embodiment, the fluid property measurement system 106 may be used to determine one or more of temperature, fluid level, density, and viscosity of fluids during chemical manufacturing processes. The temperature, fluid level, density, and viscosity of the fluid may be determined substantially simultaneously by a single fluid property measurement system 106. Determining one or more of temperature, fluid level, density, and viscosity of chemicals during manufacturing processes, such as heating, cooling, blending, dissolving, emulsifying, reacting, distillation, condensing, transporting, storing, or packaging, may facilitate better process control. Fluid property data may be input into a control feedback loop for the adjustment and fine tuning of manufacturing system parameters to achieve desired output characteristics.

In another exemplary embodiment, the fluid property measurement system 106 may be used to determine one or more of temperature, fluid level, density, and viscosity of fluids during petroleum refining processes. The temperature, fluid level, density, and viscosity of the fluid may be determined substantially simultaneously by a single fluid property measurement system 106. Determining one or more of temperature, fluid level, density, and viscosity of chemicals during refining processes, such as heating, cooling, alkylation, blending, dissolving, emulsifying, cracking, visbreaking, coking, desulfurizing, disproportioning, distillation, epoxidating, isomerizing, leaching, condensing, oxygenating, reacting, transporting, or storing, may facilitate better process control. Fluid property data may be input into a control feedback loop for the adjustment and fine tuning of refining system parameters to achieve desired output characteristics.

In another exemplary embodiment, the fluid property measurement system 106 may be used to determine one or more of temperature, fluid level, density, and viscosity of fluids during metal manufacturing processes. The temperature, fluid level, density, and viscosity of the molten metal may be determined substantially simultaneously by a single fluid property measurement system 106. Determining one or more of temperature, fluid level, density, and viscosity of metals during manufacturing processes, such as heating, cooling, decarburizing, smelting, cladding, coating, hot-dipping, plating, casting, or extrusion, may facilitate better process control. Fluid property data may be input into a control feedback loop for the adjustment and fine tuning of manufacturing system parameters to achieve desired output characteristics.

When the waveguides 110 and/or 200 and the sheath 112 (FIG. 1) are disposed at least partially within the fluid 114 (FIG. 1), the ultrasonic wave may be generated and may propagate along the length of the waveguide 110 and/or 200 and the sheath 112 (FIG. 1) during use and operation of the energy system 100. The receiver 730 and the electronics assembly 113 (FIG. 1) may be configured to calculate the amount of time that it takes for the ultrasonic waves to propagate along the waveguide 110 and/or 200 and the sheath 112 (FIG. 1). Using the times for the ultrasonic wave to propagate along different portions of the waveguide 110 and/or 200 and the sheath 112 (FIG. 1) facilitates monitoring of the level of the fluid 114 (FIG. 1) within the cooling system and monitoring density and viscosity of the fluid 114 (FIG. 1).

A method of measuring properties of the fluid 114 (FIG. 1) may include disposing at least one waveguide 110 and at least one sheath 112 (FIG. 1) at least partially within the fluid 114 (FIG. 1). The fluid property measurement system 106 may facilitate generating an ultrasonic wave from the electronics assembly 113 (FIG. 1) in the housing 108, the ultrasonic wave propagating longitudinally along the at least one waveguide 110 and the at least one sheath 112 (FIG. 1). The electronics assembly 113 (FIG. 1) may facilitate measuring the amount of time for the ultrasonic wave to travel between one end of the at least one waveguide 110 to another end of the at least one waveguide 110. The fluid property measurement system 106 may facilitate determining a level, a density, a temperature, and a viscosity of the fluid 114 (FIG. 1) simultaneously.

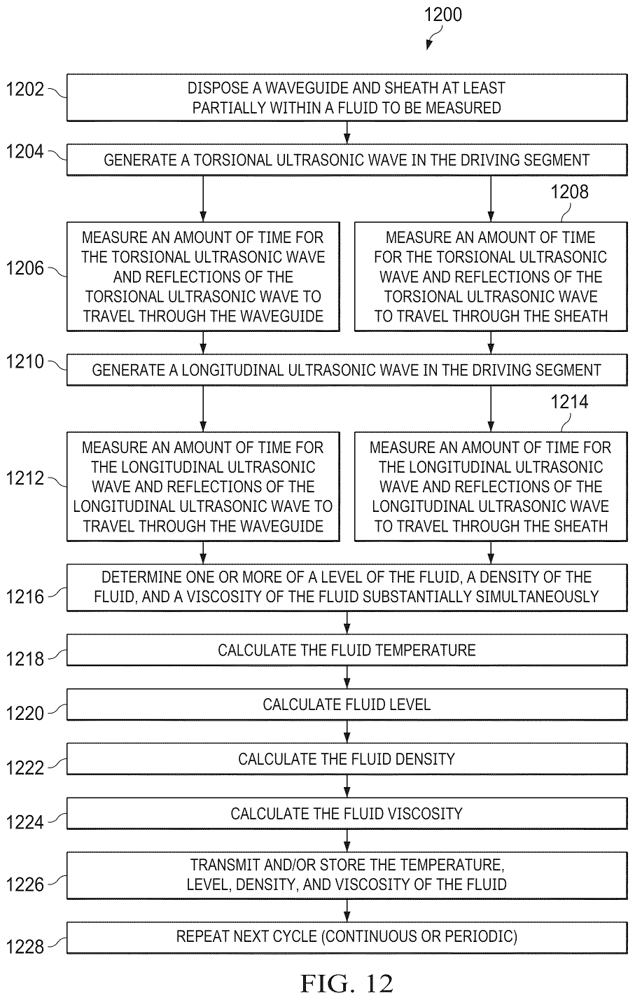

FIG. 12 illustrates a block diagram of a method 1200 of measuring fluid properties using the fluid property measurement system 106 (FIG. 11). The method 1200 executes a cycle in which (i) longitudinal-mode time-of-flight yields temperature; (ii) torsional-mode reflections from the first end and hole yield level (via partial submersion length) and density (via submerged-only segment time); and (iii) torsional-mode reflections from the first end 116, 216, 516, 616, 1016 and hole 120, 220, 1020 within the thin layer of fluid 114 between the sheath 1012 and the sensing segment 119 or the waveguide 110, 200, 500, 600, 700, 800A, 800B, 900 and/or between longitudinal cavity 124, 224, 524, 624 wall and pin 136 yield viscosity. Temperature is applied as a compensation term to calibrate the density calculations, and density is applied as a compensation term to calibrate the viscosity calculation, decoupling variable cross-sensitivities.

In act 1202, a waveguide (e.g., waveguide 110, 200, 500, 600, 700, 800A, 800B, 900 (FIGS. 1-9)) and a sheath (e.g., sheath 112, 1012 (FIGS. 1 and 10)) are disposed at least partially within a fluid. In act 1204, a torsional ultrasonic wave is generated by the driving segment. In act 1206, an amount of time for the torsional ultrasonic wave and reflections of the torsional ultrasonic wave to travel through the waveguide (e.g., the waveguide 110, 200, 500, 600, 700, 800A, 800B, 900 (FIGS. 1-9)) is measured. In act 1208, an amount of time for the torsional ultrasonic wave and reflections of the torsional ultrasonic wave to travel through the sheath (e.g., the sheath 112, 1012 (FIGS. 1 and 10)) is measured. In act 1210, a longitudinal ultrasonic wave is generated by the driving segment. In act 1212, an amount of time for the longitudinal ultrasonic wave and reflections of the torsional ultrasonic wave to travel through the waveguide (e.g., waveguide 110, 200, 500, 600, 700, 800A, 800B, 900 (FIGS. 1-9)) is measured. In act 1214, an amount of time for the longitudinal ultrasonic wave and reflections of the torsional ultrasonic wave to travel through the sheath (e.g., sheath 112, 1012 (FIGS. 1 and 10)) is measured.

In act 1216, a level of the fluid, a density of the fluid, and a viscosity of the fluid are determined substantially simultaneously. In act 1218, the fluid temperature is calculated using the following equation:

$${v}_{e} = \sqrt{\frac{{E}_{w}}{{ρ}_{w}}}$$

where vₑ is the acoustic wave speed, E_{w} is the elastic bulk modulus of the fluid, and ρ_{w} is the density of the fluid. Because the elastic bulk modulus and the density of the fluid each are a function of the temperature of the fluid, the relationship of the elastic bulk modulus and the density of the fluid may be used to calculate the temperature of the fluid when the acoustic wave speed is known.

In act 1220 the fluid level is calculated using the following equation:

$${c}_{t ◆} = X {( G / p )}^{1 / 2}$$

where cₜ is the acoustic wave speed, X is a shape factor, G is the shear modulus of the material, and p is the density of the material. The shape factor may change based on a cross-sectional shape of the waveguide. For example, for a diamond shape, such as the cusped diamond shape discussed above, the shape factor may be about 0.57. A square waveguide may have a shape factor of about 0.9184, a rectangular waveguide may have a shape factor of about 0.56, and an elliptical waveguide may have a shape factor of about 0.6. Lower shape factor may result from waveguides having greater mass loading and may result in greater sensitivity.

In act 1222, the fluid density is calculated using the following equations:

$${v}_{t} = \sqrt{\frac{G \cdot J}{{ρ}_{w} \cdot {I}_{w}}}$$

where vₜ is the torsional wave speed, G is the shear modulus of the waveguide, J is the area moment of inertia of the waveguide, ρ_{w} is the density of the waveguide, I_{w} is the mass moment of inertia of the waveguide. This equation is used to calculate a baseline for the waveguide when the waveguide is not disposed in a fluid.

$${v}_{t} = \sqrt{\frac{G \cdot J}{{ρ}_{f} \cdot {I}_{f} + {ρ}_{w} \cdot {I}_{w}}}$$

where vₜ is the torsional wave speed, G is the shear modulus of the waveguide, J is the area moment of inertia of the waveguide, ρ_{w} is the density of the waveguide, I_{w} is the mass moment of inertia of the waveguide, ρ_{f} is the fluid density, and I_{f} is the mass moment of inertia of the fluid. Using the baseline calculation above, the density of the fluid may be found.

$${v}_{t} = K \sqrt{\frac{G}{{ρ}_{w}}} [ 1 + \frac{{ρ}_{f}}{{ρ}_{w}} ( 1 - \frac{1}{K} ) ] , K < 1$$

where vₜ is the torsional wave speed, G is the shear modulus of the waveguide, J is the area moment of inertia of the waveguide, ρ_{w} is the density of the waveguide, I_{w} is the mass moment of inertia of the waveguide. This equation is used to calculate a baseline for the waveguide when the waveguide is not disposed in a fluid. and K is a dimensionless geometry constant. This equation facilitates calculating the density while simplifying the inertia calculations using the geometry constant.

In act 1224, the fluid viscosity is calculated using the following equations:

$${α}_{0} = \frac{ln ( \frac{{A}_{1}}{{A}_{2}} )}{2 x} .$$

where α₀ is the baseline resistance, A₁ is a first amplitude at a first location, A₂ is a second amplitude at a second location, x is the distance between the first amplitude measurement and the second amplitude measurement. This equation is a baseline equation configured to calculate resistance in the waveguide without a fluid present, such as resistance caused by the transducer, couplant, waveguide material, fixtures, etc.

$${α}_{s} = \sqrt{\frac{2 {ωρ}_{f} η}{{ρ}_{w} G}}$$

where αₛ is the ultrasonic attenuation coefficient, ω is the angular frequency of the ultrasonic wave, ρ_{w} is the shear modulus of the waveguide, ρ_{f} is the fluid density, η is the dynamic viscosity, and G is the shear modulus. Using these two equations the dynamic viscosity of the fluid may be calculated.

In act 1226, the fluid temperature, fluid level, fluid density, and fluid viscosity is transmitted and/or stored using the electronics assembly 113. Finally, in act 1228, method 1200 repeats this process on a continuous or periodic basis, beginning again at act 1202.

Many industrial processes require continuous measurement of fluid properties (e.g., level, density, viscosity, and temperature) under harsh conditions, such as elevated temperature/pressure, corrosive media, multiphase flow, EMI/vibration/radiation. Conventional instruments are often deployed in combinations, increasing installation labor, footprint, and maintenance. These issues are solved by the disclosed single, compact fluid property measurement system that simultaneously measures fluid level, density, viscosity, and temperature with high accuracy. The system can be constructed from a wide variety of material resistant to a range of harsh environments, while offering long service life and ease of maintenance/replacement.

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this disclosure. Indeed, various modifications of the present disclosure, in addition to those shown and described herein, such as alternative useful combinations of the elements described, may become apparent to those skilled in the art from the description. Such modifications and embodiments are also intended to fall within the scope of the appended claims and their legal equivalents.

What is claimed is:

1. A fluid property measurement system, comprising:
a waveguide;
a sheath substantially surrounding the waveguide and arranged coaxially with the waveguide; and
an electronic assembly operatively coupled to the waveguide and the sheath, the electronic assembly configured to produce a first torsional ultrasonic wave signal through the waveguide, a second torsional ultrasonic wave signal through the sheath, and a longitudinal ultrasonic wave signal through at least one of the waveguide and the sheath.

2. The fluid property measurement system of claim 1, further comprising a temperature measurement device configured to measure the temperature of at least one of the waveguide and the sheath.

3. The fluid property measurement system of claim 1, wherein the sheath comprises a reflector hole defined in a wall of the sheath.

4. The fluid property measurement system of claim 1, wherein the electronic assembly is configured to calculate a temperature based on measured amounts of time from reflections of the longitudinal ultrasonic wave signal through at least one of the waveguide and the sheath.

5. The fluid property measurement system of claim 4, wherein the electronic assembly is configured to calculate a viscosity of a fluid between the sheath and the waveguide based on measurement of the second torsional ultrasonic wave signal in the sheath.

6. The fluid property measurement system of claim 1, wherein the waveguide comprises a longitudinal cavity defined centrally within the waveguide.

7. The fluid property measurement system of claim 1, wherein the waveguide exhibits a cusped diamond shape in a cross section.

8. The fluid property measurement system of claim 7, wherein the cusped diamond shape of the waveguide comprises at least one fin at a point of the cusped diamond shape.

9. The fluid property measurement system of claim 1, wherein the sheath further comprises a hole in a wall of the sheath.

10. The fluid property measurement system of claim 1, wherein the waveguide comprises at least one piezoelectric crystal configured to generate at least one of the first torsional ultrasonic wave signal, the second torsional ultrasonic wave signal, and the longitudinal ultrasonic wave signal.

11. An energy system comprising:
a cooling system;
at least one fluid chamber of the cooling system configured to house a cooling fluid; and
a waveguide in the at least one fluid chamber, the waveguide comprising:
a sensing segment configured to be at least partially disposed in the cooling fluid; and
a driving segment comprising at least two driving elements configured to generate a longitudinal ultrasonic wave signal and a torsional ultrasonic wave signal in the sensing segment.

12. The energy system of claim 11, further comprising a sheath disposed in the at least one fluid chamber, the sheath disposed radially around the sensing segment of the waveguide and substantially coaxial with the sensing segment of the waveguide.

13. The energy system of claim 11, wherein the waveguide comprises a longitudinal cavity defined in the sensing segment.

14. The energy system of claim 13, further comprising at least one temperature measurement device disposed in the longitudinal cavity.

15. The energy system of claim 13, wherein the longitudinal cavity exhibits a substantially circular cross-section.

16. The energy system of claim 13, wherein the waveguide further comprises a pin disposed in the longitudinal cavity.

17. A method of measuring properties of a fluid, the method comprising:
disposing a waveguide of a fluid property measurement system at least partially within a fluid;
generating a first torsional ultrasonic wave in the waveguide;
measuring an amount of time for the first torsional ultrasonic wave and reflections of the first torsional ultrasonic wave to travel through the waveguide; and
substantially simultaneously determining one or more of a level of the fluid, a density of the fluid, and a viscosity of the fluid based on a difference between the measured amounts of time.

18. The method of claim 17, further comprising:
generating a longitudinal ultrasonic wave in the waveguide;
measuring an amount of time for the longitudinal ultrasonic wave and reflections of the longitudinal ultrasonic wave to travel through the waveguide; and
determining a temperature of the fluid from the longitudinal ultrasonic wave based on the measured amount of time.

19. The method of claim 17, wherein measuring the amount of time for the first torsional ultrasonic wave and reflections of the first torsional ultrasonic wave to travel through the waveguide comprises:
measuring an amount of time for the first torsional ultrasonic wave to travel between a first end of the waveguide and a second end of the waveguide; and
measuring an amount of time for a reflection of the first torsional ultrasonic wave to travel from a reflective hole defined in the waveguide to the second end of the waveguide.

20. The method of claim 17, further comprising:
generating a second torsional ultrasonic wave in a sheath around the waveguide;
measuring an amount of time for the second torsional ultrasonic wave to travel through the sheath; and
determining a viscosity of the fluid based on the measured amount of time.
